(19) United States
(12) Patent Application Publication
(10) Pub. No.: US 2017/0072391 A1
(43) Pub. Date: Mar. 16, 2017

(54) PHOTOCATALYTIC HYDROGEN PRODUCTION FROM WATER OVER MIXED PHASE TITANIUM DIOXIDE NANOPARTICLES

(71) Applicant: SABIC Global Technologies B.V., Amsterdam (NL)

(72) Inventors: Shahid Bashir, Thuwal (SA); Ahmed Khaja Wahab, Thuwal (SA); Hicham Idriss, Thuwal (SA)

(21) Appl. No.: 15/308,955

(22) PCT Filed: Jun. 30, 2015
(86) PCT No.: PCT/IB2015/054928

§ 371 Date: Nov. 4, 2016

Related U.S. Application Data
(60) Provisional application No. 62/022,962, filed on Jul. 10, 2014.

(51) Int. Cl. B01J 35/00; B01J 23/42; C01B 3/04; B01J 35/10; B01J 37/08; B01J 37/02; B01J 21/06; B01J 35/02

(52) U.S. Cl. CPC B01J 35/004; B01J 21/063; B01J 23/42; B01J 35/0013; B01J 35/023; B01J 35/1014; B01J 37/08; B01J 37/0221; C01B 3/042

(57) ABSTRACT

Photocatalysts and methods of using photocatalysts for synergistic production of hydrogen from water are disclosed. The photocatalysts include photoactive titanium dioxide particles having an anatase to rutile ratio of at least 1.5:1 and electrically conductive material deposited on the titanium dioxide particle.

### CROSS REFERENCE TO RELATED APPLICATIONS

This application claims benefit to U.S. Provisional Patent Application No. 62/022,962 titled, “PHOTOCATALYTIC HYDROGEN PRODUCTION FROM WATER OVER MIXED PHASE TITANIUM DIOXIDE NANOPARTICLES”, filed Jul. 10, 2014. The entire contents of the referenced application is incorporated herein by reference.

### BACKGROUND OF THE INVENTION

A. Field of the Invention

The invention generally concerns mixed phase titanium dioxide nanoparticles that can be used to produce hydrogen and oxygen from water in photocatalytic reactions. In particular, the nanoparticles can have a mean particle size of 95 nanometers (nm) or less and a ratio of anatase to rutile of at least 1.5:1.

B. Description of Related Art

Hydrogen production from water offers enormous potential benefits for the energy sector, the environment, and the chemical industry. While methods currently exist for producing hydrogen and oxygen from water, many of these methods can be costly, inefficient, or unstable. For instance, photoelectrochemical (PEC) water splitting requires an external bias or voltage and a costly electrode (e.g., Pt-based).

With respect to photocatalytic electrolysis of water from light sources, while many advances have been achieved in this area, most materials are either unstable under realistic water splitting conditions or require considerable amounts of other components (e.g., large amounts of sacrificial hole or electron scavengers) to work, thereby offsetting any gained benefits. By way of example, a semiconductor photocatalyst is a material that can be excited upon receiving energy equal to or higher than its electronic band gap. Upon photo-excitation, electrons are transferred from the valence band (VB) to the conduction band (CB), resulting in the formation of an excited electron (in the CB) and a hole (in the VB). In the case of water splitting, electrons in the CB reduce hydrogen ions to H₂ and holes in the VB oxidize oxygen ions to O₂. One of the main limitations of most photocatalysts is the fast electron-hole recombination, a process that occurs at the nanosecond scale, while the oxidation-reduction reactions are much slower (microsecond time scale). Over 90% of photo-excited electron-hole pairs disappear before reaction by radiative and non-radiative decay mechanisms. To increase the electron life time metal deposition on the semiconductor surfaces are routinely used while organic compounds such as alcohols and glycols are added to the aqueous media to increase the hold lifetime. Current photocatalysts such as those that utilize photoactive materials having a uniform phase structure suffer from these inefficiencies.

### SUMMARY OF THE INVENTION

A solution to the aforementioned inefficiencies surrounding current water-splitting photocatalysts has been discovered. In particular, the solution resides in using mixed-phase TiO₂ nanoparticles having a mean particle size of 95 nanometers (nm) or less and a ratio of anatase to rutile of at least 1.5:1 as photocatalysts. The mixed phase titanium dioxide nanoparticles are the reaction or transformational product of single phase titanium dioxide anatase nanoparticles having a mean particles size of 95 nm or less that have been subjected to heat. It has unexpectedly been found that these transformed photocatalysts demonstrate increased hydrogen production when compared with similar catalysts made from microparticles rather than the nanoparticles of the present invention. Without wishing to be bound by theory, it is believed that subjecting the nanoparticles to heat results in a higher degree of crystallinity, which can then reduce the likelihood that an excited electron will spontaneously revert back to its non-excited state (i.e., the electron-hole recombination rate can be reduced or delayed for a sufficient period of time). Further, it is believed that the anatase to rutile ratio of at least 1.5:1 allows for the efficient transfer of charge carriers (electrons) from the rutile phase to the anatase phase, thereby further reducing the likelihood that an electron-hole recombination event would occur. The improved efficiency of the transformed photocatalysts of the present invention allows for a reduced reliance on additional materials such as sacrificial agents, thereby decreasing the complexity and costs associated with using the photocatalysts in water-splitting applications and systems.

In one aspect of the present invention, there is disclosed a photocatalyst that includes TiO₂ The TiO₂ includes mixed phase titanium dioxide nanoparticles having mean particle size of 95 nanometers (nm) or less and a ratio of anatase and rutile phases of at least 1.5:1. The ratio of anatase and rutile phases in the nanoparticles can range from 1.5:1 to 10:1, is about 5:1, or is about 4:1. Electrically conductive material may be deposited on the surface of the titanium dioxide. The mixed phase titanium dioxide nanoparticles are the reaction product single phase titanium dioxide anatase nanoparticles having a mean particle size of 95 nm or less and heat. The single phase TiO₂ anatase nanoparticles can be heated isochronally at a desired temperature ranging from about 700° C. to about 800° C. to form the mixed phase TiO₂ nanoparticles. In some instances, the single phase TiO₂ anatase nanoparticles are heated isochronally at a temperature ranging from about 740° C. for one hour. The surface area of the mixed phase titanium dioxide nanoparticles is at least 15 m²/g, or from about 15 m²/g to about 30 m²/g. The mean particle size of the mixed phase titanium dioxide nanoparticles ranges from about 10 nm to about 80 nm, from about 15 nm to about 50 nm, from about 20 nm to about 40 nm, or from about 15 nm to about 20 nm.

Electrically conductive material dispersed on the surface of the nanoparticles may increase the efficiency of water splitting reactions. The metal material may include a metal or metal compound of silver (Ag), rhodium (Rh), gold (Au), platinum (Pt), palladium (Pd), or any combination thereof In a preferred embodiment, the electrically conductive material is platinum. The photocatalyst may include about 0.05 wt. % to about 5 wt. % of the electrically conductive material. Such amounts can be less than 5, 4, 3, 2, 1, or 0.5 wt. % of the total weight of the photocatalyst. The electroconductive material may be impregnated to the mixed phase titanium dioxide. The TiO₂ nanoparticle photocatalyst has a band gap between about 3.0 electron volts (eV) and 3.2 eV. A Ti2p_{3/2} binding energy of the mixed phase TiO₂ photocatalyst falls in between that of single phase TiO₂ anatase particle and a single phase TiO₂ rutile particle.

The photocatalysts of the present invention are capable of splitting water in combination with a light source. No external bias or voltage is needed to efficiently split water. The hydrogen production rate from water can be modified as desired by subjecting the system to different amounts of light or light flux. In particular aspects, the photocatalysts of the present invention can be used in water splitting systems to provide a hydrogen production rate from water between 1×10⁻⁴ and 3×10⁻³ mol/g_{Catal} min under direct sunlight. It was surprisingly found that the photocatalyst is capable of producing hydrogen (H₂) from water at an increased rate as compared to production of H₂ from water under the same conditions and using a similar mixed phase titanium dioxide microparticle photocatalyst. In some instances, the photocatalysts of the present invention are capable of catalyzing the photocatalytic oxidation of an organic compound.

Also disclosed is a composition that includes a photocatalyst of the invention, water, and a sacrificial agent that can be used for water splitting. With a light source, the water can be split and hydrogen and oxygen gas formation can occur. In particular instances, the sacrificial agent may further prevent electron/hole recombination. In some instances, the composition includes 0.1 to 5 g/L of the photocatalyst. Notably, the efficiency of the photocatalysts of the present invention allows for one to use substantially low amounts (or none at all) of sacrificial agent when compared to known systems. In particular instances, 0.1 to 10 w/v %, or preferably 2 to 7 w/v %, of the sacrificial agent may be included in the composition. Non-limiting examples of sacrificial agents that can be used include methanol, ethanol, propanol, n-butanol, iso-butanol, iso-methyl tert-butyl ether, ethylene glycol, propylene glycol, glycerol, oxalic acid, or any combination thereof. In particular aspects, ethanol, ethylene glycol, glycerol, or a combination thereof is used.

In another aspect of the present invention, there is disclosed a system for producing hydrogen gas and/or oxygen gas from water. The system can include a container (e.g., transparent or translucent containers or opaque containers such as those that can magnify light (e.g., opaque container having a pinhole(s)) and a composition that includes photocatalyst of the present invention, water, and optionally a sacrificial agent. The container in particular embodiments is transparent or translucent. The system can also include a light source for irradiating the composition. The light source can be natural sunlight or can be from a non-natural or artificial source such as a UV lamp. While the system may use an external bias or voltage, such an external bias or voltage is not needed due to the efficiency of the photocatalysts of the present invention. In particular aspects, the method can be practiced such that the hydrogen production rate from water is between 1×10⁻⁴ to 3×10⁻³ mol/g_{Catal} min with direct sunlight.

In the context of the present invention embodiments 1-41 are described. Embodiment 1 is a photocatalyst that includes (a) mixed phase titanium dioxide nanoparticles having a mean particle size of 95 nanometers (nm) or less and having a ratio of anatase to rutile of at least 1.5:1; and (b) an electrically conductive material deposited on the surface of the titanium dioxide nanoparticles, wherein the mixed phase titanium dioxide nanoparticles are the reaction product of single phase titanium dioxide anatase nanoparticles having a mean particle size of 95 nm or less and heat. Embodiment 2 is the photocatalyst of embodiment 1, wherein a surface area of the mixed phase titanium dioxide nanoparticles is at least 15 m²/g. Embodiment 3 is the photocatalyst of embodiment 1, wherein a surface area of the mixed phase titanium dioxide nanoparticles ranges from about 15 m²/g to about 30 m²/g. Embodiment 4 is the photocatalyst of any one of embodiments 1 to 3, wherein the ratio of anatase and rutile phase ranges from 1.5:1 to 10:1. Embodiment 5 is the photocatalyst of any one of embodiments 1 to 3, wherein the anatase phase to rutile phase ratio is about 5:1. Embodiment 6 is the photocatalyst of any one of embodiments 1 to 3, wherein the anatase phase to rutile phase is ratio about 4:1. Embodiment 7 is the photocatalyst of any one of embodiments 1 to 6, wherein the mean particle size ranges from about 10 nm to about 80 nm, or from about 15 nm to about 50 nm, or from about 20 nm to about 40 nm, or from about 15 nm to about 20 nm. Embodiment 8 is the photocatalyst of any one of embodiments 1 to 7, wherein the Ti2p_{3/2} binding energy as determined by X-Ray PhotoElectron Spectroscopy (XPS) falls in between that of single phase TiO₂ anatase particle and a single phase TiO₂ rutile particle. Embodiment 9 is the photocatalyst of any one of embodiments 1 to 8, wherein the electrically conductive material includes a metal or a metal compound thereof. Embodiment 10 is the photocatalyst of any one of embodiments 1 to 9, wherein the electrically conductive material includes silver (Ag), rhodium (Rh), gold (Au), platinum (Pt), palladium (Pd) or any combination thereof. Embodiment 11 is the photocatalyst of any one of embodiments 1 to 9, wherein the electrically conductive material includes Pt. Embodiment 12 is the photocatalyst of any one of embodiments 1 to 11, wherein the photocatalyst includes from about 0.05% to about 5% by weight of the electrically conductive material. Embodiment 13 is the photocatalyst of any one of embodiments 1 to 12, wherein the photocatalyst includes about 1% by weight of Pt. Embodiment 14 is the photocatalyst of any one of embodiments 1 to 13, wherein the single phase TiO₂ anatase nanoparticles have been heated isochronally at a temperature ranging from about 700° C. to about 800° C. for a desired period of time. Embodiment 15 is the photocatalyst of any one of embodiments 1 to 13, wherein the single phase TiO₂ anatase particles have been heated at a temperature of about 740° C. for one hour. Embodiment 16 is the photocatalyst of any one of embodiments 1 to 15, wherein the photocatalyst has a band gap between about 3.0 electron volts (eV) and 3.2 eV. Embodiment 17 is the photocatalyst of any one of embodiments 1 to 16, wherein the photocatalyst is capable of catalyzing the photocatalytic splitting of water. Embodiment 18 is the photocatalyst of any one of embodiments 1 to 17, wherein the photocatalyst is capable of producing H₂ from water at an increased rate as compared to production of H₂ from water under the same conditions and using a mixed phase titanium dioxide photocatalyst having a substantially same amount of anatase and rutile phases and a particle size of greater than 100 nm. Embodiment 19 is the photocatalyst of any of embodiments 17 or 18, wherein the photocatalyst is comprised in a composition that includes the water. Embodiment 20 is the photocatalyst of embodiment 19, wherein the composition further includes a sacrificial agent. Embodiment 21 is the photocatalyst of embodiment 20, wherein the sacrificial agent includes one or more alcohols, diols, polyols, dioic acids, and any combination thereof. Embodiment 22 is the photocatalyst of any one of embodiments 20 or 21, wherein the sacrificial agent includes methanol, ethanol, propanol, iso-propanol, n-butanol, iso-butanol, ethylene glycol, propylene glycol, glycerol, or oxalic acid, or any combination thereof. Embodiment 23 is the photocatalyst of any one of embodiments 20 or 21, wherein the sacrificial agent is ethanol or ethylene glycol. Embodiment 24 is the photocatalyst of any one of embodiments 20 to 23, wherein the composition includes 0.1 to 5 g/L of the photocatalyst and/or 0.1 to 5 vol. % of the sacrificial agent. Embodiment 25 is the photocatalyst of any one of embodiments 17 to 24, wherein the H₂ production rate from water is 1×10⁻⁴ to 3×10⁻³ mol/g_{catal} min under direct sunlight.

Embodiment 26 is a method of producing a photocatalyst of any one of embodiments 1-25, that includes (a) heating single phase titanium dioxide anatase nanoparticles having a mean particle size of 95 nanometers (nm) or less; (b) forming mixed phase titanium dioxide nanoparticles having a mean particle size of 95 nm or less, wherein the mixed phase titanium dioxide nanoparticles includes anatase and rutile phases at a ratio of at least 1.5:1; (c) depositing an electroconductive material on the surface of the mixed phase titanium dioxide nanoparticles. Embodiment 27 is the method of embodiment 26, wherein a surface area of the mixed phases titanium dioxide nanoparticles ranges from about 15 m²/g to about 30 m²/g. Embodiment 28 is the method of any one of embodiments 26 or 27, wherein the electroconductive material includes silver (Ag), rhodium (Rh), gold (Au), platinum (Pt), palladium (Pd) or mixtures thereof. Embodiment 29 is the method of any one of embodiments 26 to 27, wherein the electroconductive material includes platinum (Pt) or a compound thereof. Embodiment 30 is the method of any one of embodiments 26 to 29, wherein depositing the electroconductive material includes contacting the mixed phase TiO₂ nanoparticles with an acidic aqueous solution that includes a salt of the electroconductive material. Embodiment 31 is the method of any one of embodiments 26 to 30, wherein heating includes heating the single phase titanium dioxide anatase nanoparticles isochronally in a temperature range from about 700° C. to about 800° C. for one hour. Embodiment 32 is the method of any one of embodiments 26 to 31, further including calcining mixed phase titanium dioxide anatase nanoparticles.

Embodiment 33 is a system for producing H₂ from H₂O that includes (a) a container that includes a mixture of photocatalyst of any one of embodiments 1 to 25, water and a sacrificial agent; and (b) a light source configured to provide light to the mixture. Embodiment 34 is the system of embodiment 33, wherein the light source includes sunlight. Embodiment 35 is the system of any one of embodiments 33 or 34, wherein the light source includes an ultra-violet light. Embodiment 36 is the system of any one of embodiments 33 to 35, wherein an external bias is not used to produce the H₂. Embodiment 37 is the system of any one of embodiments 33 to 36, wherein the container is transparent.

Embodiment 38 is a method for producing H₂ from water, that includes (a) obtaining a system of any one of embodiments 33 to 37; and (b) subjecting the mixture to the light source for a sufficient period of time to produce the H₂ from the water. Embodiment 39 is the method of embodiment 38, further including producing oxygen (O₂) from the water. Embodiment 40 is the method of any one of embodiments 38 or 39, wherein the light source is sunlight and H₂ is produced at a rate from about 1×10⁻⁴ to about 3×10⁻³ mol/g_{Catal} min. Embodiment 41 is the method of any one of embodiments 38 to 40, wherein the H₂ is produced at an increased rate as compared to a production of H₂ under the same conditions and using a mixed phase titanium dioxide photocatalyst having a substantially same amount of anatase and rutile phases and a particle size of 95 nm or more.

The following includes definitions of various terms and phrases used throughout this specification.

“Water splitting” or any variation of this phrase describes the chemical reaction in which water is separated into oxygen and hydrogen.

“Nanoparticle” refers to particles having a mean particle size of less than 100 nanometers.

“Microparticle” refers to particles having a mean particle size of 100 nm or more.

“Inhibiting,” “preventing,” or “reducing” or any variation of these terms, when used in the claims or the specification includes any measurable decrease or complete inhibition to achieve a desired result. By way of example, reducing the likelihood for an excited electron in the conductive band to recombine with a hole in the valence band encompasses situations where a decrease in the number of electron/hole recombination events occurs or an increase in the time it takes for an electron/hole recombination event to occur such that the increase in time allows for the electron to reduce hydrogen ions rather than to recombine with its corresponding hole. In either instance, the photocatalysts of the present invention can be compared with photocatalysts of mixed phase TiO₂ anatase particles to rutile phase microparticles (i.e., particles having a mean particle size of greater than 100 nm).

“Effective” or any variation of this term, when used in the claims or specification, means adequate to accomplish a desired, expected, or intended result.

The terms “about” or “approximately” are defined as being close to as understood by one of ordinary skill in the art, and in one non-limiting embodiment the terms are defined to be within 10%, preferably within 5%, more preferably within 1%, and most preferably within 0.5%.

The use of the word “a” or “an” when used in conjunction with the term “comprising” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The photocatalysts of the present invention can “comprise,” “consist essentially of,” or “consist of” particular components, compositions, ingredients, etc. disclosed throughout the specification. With respect to the transitional phase “consisting essentially of,” in one non-limiting aspect, a basic and novel characteristic of the photoactive catalysts and materials of the present invention are their ability to efficiently use excited electrons in water-splitting applications to produce hydrogen.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description.

### BRIEF DESCRIPTION OF THE DRAWINGS

FIG. 1 is a schematic of the TiO₆ octahedra in anatase and rutile phases along the c-axis.

FIG. 2A depicts a transmission electron microscopy image of a single phase titanium dioxide anatase microparticle heated for 1 hour at 1000° C.

FIG. 2B depicts a transmission electron microscopy images of the single phase titanium dioxide anatase microparticle of FIG. 2A after 5 hours of heating at 1000° C.

FIG. 3 is a schematic of an embodiment of a water-splitting system using the photocatalysts of the invention.

FIG. 4 are XRD spectra of embodiments of titanium dioxide nanoparticle samples having various amounts of rutile phase.

FIG. 5 are XRD spectra of titanium dioxide microparticle comparison samples having various amounts of rutile phase.

FIG. 6 depict UV-Vis spectra of absorbance in Tauc units versus electron volts (eV) of photocatalysts of the invention containing 1 wt. % Pt/TiO₂ nanoparticles with different percentages of rutile.

FIG. 7 depicts UV-Vis spectra of absorbance in Tauc units versus electron volts (eV) of comparison photocatalysts containing 1 wt. % Pt/TiO₂ microparticles with different percentages of rutile.

FIG. 8 are XPS spectra of the Pt4f of comparison photocatalysts containing 1 wt. % Pt/TiO₂ microparticle samples.

FIG. 9 is an XPS spectrum of the Pt4f of photocatalyst of the invention containing 1 wt. % Pt/TiO₂ nanoparticles containing 10% rutile.

FIG. 10 are XPS spectra of the Ti2p of pure TiO₂ rutile, pure TiO₂ anatase, and photocatalysts of the invention containing mixed phase nanoparticles having various percentages of rutile.

FIG. 11 depict XPS spectra of the Valence Band region of comparison photocatalysts of pure 1 wt. % Pt/TiO₂ rutile before and after Argon ion sputtering.

FIG. 12 depict XPS spectra of the Valence Band region of a comparison photocatalysts of 1 wt. % Pt/TiO₂ anatase and photocatalysts of the invention containing mixed phase 1 wt. % Pt/ TiO₂ nanoparticles having various percentages of rutile phase before and after Argon ion sputtering.

FIG. 13 is a graphical depiction of hydrogen production versus time for photocatalysts of the invention containing 1 wt. % Pt/TiO₂ nanoparticles with increasing rutile content.

FIG. 14 is a graphical depiction of hydrogen production versus time for comparison photocatalysts of 1 wt. % Pt/TiO₂ microparticles with increasing rutile content.

FIG. 15 is a graphical depiction of hydrogen production from 1 wt. % Pt/TiO₂ nanoparticles photocatalysts of the invention and 1 wt. % Pt/TiO₂ microparticles comparison photocatalysts versus rutile content.

### DETAILED DESCRIPTION OF THE INVENTION

While hydrogen-based energy from water has been proposed as a solution to the current problems associated with carbon-based energy (e.g., limited amounts and fossil fuel emissions), the currently available technologies are expensive, inefficient, and/or unstable. The present application provides a solution to these issues. The solution is predicated on the use of heat-treated mixed phase titanium dioxide nanoparticles having a mean particle size of 95 nanometers (nm) or less and a ratio of anatase to rutile of at least 1.5:1 as photocatalysts. It has been unexpectedly found that photocatalyst of the invention produces higher amounts of hydrogen in photocatalytic water-splitting reactions than similar photocatalysts made from microparticles. This higher hydrogen production rate is attributed to a synergistic effect between the phase ratio and the particle size of the titanium dioxide nanoparticles.

These and other non-limiting aspects of the present invention are discussed in further detail in the following sections.

### A. Photoactive Catalysts

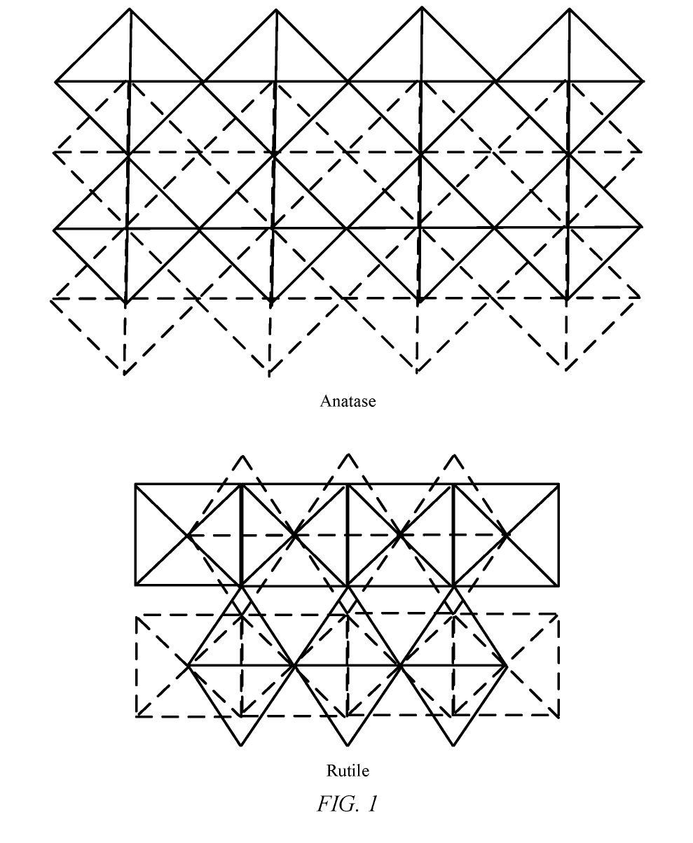

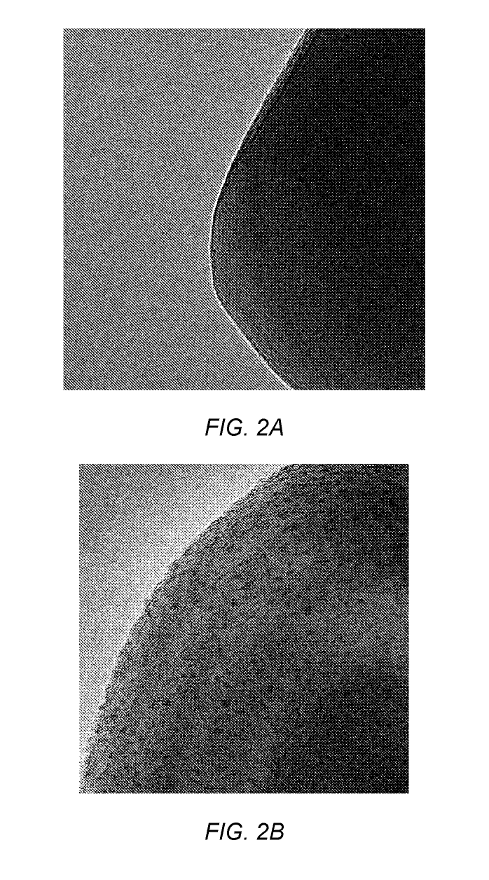

The photocatalyst is composed of titanium dioxide particles having two main polymorphs, anatase and rutile. The particles have different properties and different photocatalytic performance. Combination of these properties provides for a photocatalyst having better physical and electron transfer properties. While anatase and rutile both have a tetragonal crystal system consisting of TiO₆ octahedra, their phases differ in that anatase octahedras are arranged such that four edges of the octahedras are shared, while in rutile, two edges of the octahedras are shared. FIG. 1 is a schematic of the TiO₆ octahedra in anatase and rutile along the c-axis. The shared edges are in bold lines. These different crystal structures may account for the different efficiencies observed for transfer of charge carriers (electrons) in the rutile and anatase phases and the different physical properties of the catalyst. For example, anatase is more efficient than rutile in the charge transfer, but is not as durable as rutile. A more durable photocatalyst may extend the life of the catalyst during use. Without wishing to be bound by theory, it is believed that the when rutile nanoparticles are formed on the surface of the single phase anatase nanoparticles, the electron-hole recombination rate is retarded due to electron transfer from the rutile to the anatase phase. In other words, because the electron-hole recombination rate is fast in rutile and slow in anatase (See, for example, Xu, et al. in Physics Review Letters 2011, Vol. 106, pp. 138302-1 to 138302-4) and because the number of electron and holes is higher in rutile than in anatase at a given wavelength capable of exciting both materials, the mixture performs better in photocatalytic water-splitting reactions. The materials, therefor benefits from a large number of carriers (in rutile) and a slow rate of recombination (in anatase) giving them more time to make the reduction of hydrogen ions to hydrogen molecules and the oxidation of oxygen ions to oxygen molecules. Heat-treating the single phase titanium dioxide anatase nanoparticle produces small particles of rutile on top of anatase particles, thus maximizing the interface between both phases and at the same time allowing for a large number of adsorbates (water and ethanol) to be in contact with both phases, due to the initial small particle size. FIG. 2A depicts a transmission electron microscopy image of a single phase titanium dioxide anatase microparticle heated for 1 hour at 1000° C. FIG. 2B depicts a transmission electron microscopy images of the single phase titanium dioxide anatase microparticle of FIG. 2A after 5 hours of heating at 1000° C. Comparing FIG. 2A to FIG. 2B, an increased amount of TiO₂ rutile phase particles having a size of about 1-2 nm are observed after 5 hours of heating as compared to the number of TiO₂ rutile phase particles observed after 1 hour of heating. Thus, titanium dioxide photocatalysts having various amounts of rutile and anatase extend the life of the catalyst and maximize efficient electron transfer properties.

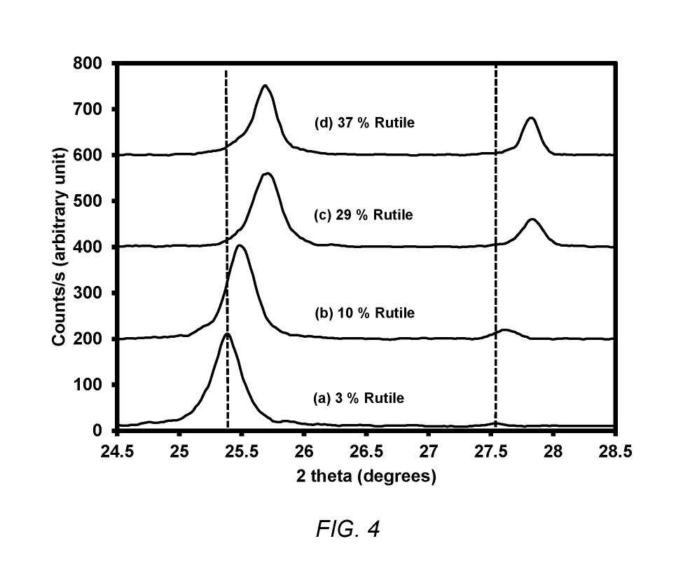

In one aspect of the invention, mixed phase titanium dioxide anatase and rutile may be the reaction (transformation) product obtained from heat-treating single phase titanium dioxide anatase at selected temperatures. Single phase TiO₂ anatase nanoparticles can be purchased from various manufacturers and suppliers (e.g., Titanium (IV) oxide anatase nanoparticles in a variety of sizes and shapes can be obtained from Sigma-Aldrich® Co. LLC (St. Louis, Mo., USA) and from Alfa Aesar GmbH & Co KG, A Johnson Matthey Company (Germany)); L.E.B. Enterprises, Inc. (Hollywood, Fla. USA)). A surface area of the single phase TiO₂ anatase nanoparticles ranges from about 45 m²/g to about 80 m²/g, or from 50 m²/g to 70 m²/g, or preferably about 50 m²/g. The particle size of the single phase TiO₂ anatase nanoparticles is less than 95 nanometers, less than 50 nm, less than 20, or preferably between 10 and 25 nm. Reaction conditions can be varied based on the TiO₂ anatase particle size and/or method of heating (See, for example, Hanaor et al. in Review of the anatase to rutile phase transformation, J. Material Science, 2011, Vol. 46, pp. 855-874), and are sufficient to transform single phase titanium dioxide to mixed phase titanium dioxide anatase and rutile. For example, titanium dioxide anatase can be transformed into a mixed phase polymorph by flame pyrolysis of TiCl₄, solvothermal/hydrothermal methods, chemical vapor deposition, and physical vapor deposition methods. A non-limiting example of transforming nanoparticles of TiO₂ anatase nanoparticles to mixed phase TiO₂ anatase and rutile nanoparticles includes heating single phase TiO₂ anatase nanoparticles isochronally at a temperature of 700-800° C. for about 1 hour to transform the nanoparticles of TiO₂ anatase phase to nanoparticles of mixed phase TiO₂ anatase phase and rutile phase (See, for example FIG. 4 in the Examples). In a preferred embodiment, titanium dioxide anatase is heated to a temperature of 780° C. to obtain mixed phase titanium dioxide containing about 37% rutile. Notably, it was discovered that when mixed phase TiO₂ nanoparticles having a ratio of anatase to rutile of at least 1.5:1 or greater is used as a photocatalyst in water-splitting processes, higher production rates of hydrogen were observed as compared to similar photocatalyst containing mixed phase titanium dioxide microparticles. This higher rate of hydrogen production is attributed to a synergistic effect between the particle size and phase ratio of the titanium dioxide nanoparticles. Without wishing to be bound by theory, it is believed that this ratio and the particle structure may allow for the efficient transfer of charge carriers (electrons) from the rutile phase to the anatase phase, where said charge carries in the anatase phase have an increased chance of being transferred to the metal conducting materials rather than undergoing an electron-hole recombination event. The mixed phase TiO₂ nanoparticles of the present invention can have a ratio of anatase and rutile phase ranges from 1.5:1 to 10:1, from 6:1 to 5:1, or from 5:1 to 4:1. The percentage of anatase to rutile the titanium dioxide polymorph can be determined using powder X-ray diffraction (XRD) techniques. For example, a Philips X′pert-MPD X-ray powder diffractometer may be used to analyze powder samples of titanium dioxide polymorphs. Using the areas of these peaks the amounts of rutile phase in the titanium dioxide polymorph can be determined using the following equation:

$$\% rutile = \frac{1}{( \frac{A}{R} \times 0.884 ) + 1} \times 100 \qquad ( 1 )$$

where A is the area of anatase peak; R is the area of rutile peak as determined by XRD; and 0.884 is a scattering coefficient.

In an aspect of the invention, it was surprisingly found that the percentage in the change of surface area of mixed phase titanium dioxide anatase and rutile nanoparticles was significantly different than the percentage change in the surface area of the mixed phase titanium dioxide anatase and rutile microparticles relative to the respective starting materials. For example, the surface area of the titanium dioxide microparticles decreased by about 40% at a 25% conversion to rutile phase relative to the surface area of the starting material as determined by Brunauer-Emmett-Teller (BET) methods. In contrast, the surface area of the titanium dioxide nanoparticles decreased by about 70% at a 29% conversion to rutile phase relative to the surface area of the staring material. In particular aspects of the invention, a surface area of the mixed phase TiO₂ nanoparticles may decrease by a factor of at least 0.1, at least 0.4, or at least 0.5. The resulting mixed phase titanium dioxide nanoparticles have a surface area of about 15 m²/g, or preferably from 15 m²/g to 30 m2/g. Without wishing to be bound by theory, it is believed that the decrease in the nanoparticle surface area as compared to the microparticle surface area demonstrates that less sintering has occurred on the catalyst surface and a higher degree of crystallinity has been obtained. A higher degree of crystallinity leads to minimum perturbation of the titanium dioxide wave function, which allows enhanced migration of electrons from the bulk portion of the titanium dioxide particle to the surface of the titanium dioxide particle and less recombination of electrons.

Further, during heating, the particle size of the pure anatase changes from a single modal distribution to a bimodal distribution, where the anatase and rutile phases have different particle sizes. The overall particle size distribution, however, of the resulting TiO₂ remains less than 100 nm. During heat treatment, the particle size of the original anatase phase increases by a factor of at least 1.5, at least 2, or at least 0.45, while the particle size of the formed rutile phase is from about 0 nm to less than 100 nm depending on the temperature used to form the rutile phase (See, for example, the d values for anatase and rutile phases in Table 1 of the Examples). Even though an increase in particles size is observed during heating, the mean particle size of the mixed phase TiO₂ nanoparticles is less than 100 nm. The mixed phased nanoparticles of the invention have a mean particle size of less than 95 nm, from about 10 nm to about 80 nm, from about 15 nm to about 50 nm, from about 20 nm to about 50 nm, or from about 15 nm to about 20 nm.

In a further aspect of the invention, transforming the single phase TiO₂ anatase to a mixed phase TiO₂ having a anatase to rutile phase ratio of at least 1.5:1 changes the binding energy and the band gap relative to single phase TiO₂ anatase and single phase TiO₂ rutile. This change in binding energy and band gap is believed to allow efficient transfer of charge carriers (electrons) from the rutile phase to the anatase phase, where said charge carries in the anatase phase have an increased chance of being transferred to the metal conducting materials rather than undergoing an electron-hole recombination event. The TiO₂ nanoparticles of the present invention have a Ti2p_{3/2} binding energy as determined by X-ray photoelectron spectroscopy (XPS) that is in between that of single phase TiO₂ anatase and single phase TiO₂ rutile. The mixed phase TiO₂ nanoparticles also have a band gap between about 3.0 electron volts (eV) and 3.2 eV.

Electroconductive material may be deposited on the surface of the mixed phase TiO₂ nanoparticles to increase the photocatalytic activity of the TiO₂. The electroconductive material includes highly conductive materials, making them well suited to act in combination with the photoactive material to facility transfer of excited electrons to hydrogen before an electron-hole recombination event occurs or by increasing the time that such an event occurs. The electroconductive material can also enhance efficiency via resonance plasmonic excitation from visible light, enabling capture of a broader range of light energy. The electroconductive materials include noble metals such as, for example, platinum, gold, silver and palladium as metals or metal salts. Electroconductive material (i.e., platinum, gold, silver, and palladium) can be obtained from a variety of commercial sources in a variety of forms (e.g., solutions, particles, rods, films, etc.) and sizes (e.g., nanoscale or microscale). By way of example, Sigma-Aldrich® Co. LLC and Alfa Aesar GmbH & Co KG offer such products. Alternatively, they can be made by any process known by those of ordinary skill in the art. The electrically conducting material may be deposed on the surface of the mixed phase titanium dioxide nanoparticles. Deposition can include attachment, dispersion, and/or distribution of the metal particles on the surface of the photoactive material or TiO₂ particles. A non-limiting example of depositing the electrically conductive material on the photoactive material includes impregnating the mixed phase TiO₂ nanoparticles with a solution of metal salt. Impregnation may include contacting (for example, spraying or mixing) the mixed phase TiO₂ nanoparticles with an acidic aqueous metal salt solution to form a mixture. The mixture may be stirred at a temperature of about 70° C. to 80° C. for about 10 h, 12 h, or longer. After stirring, the water may be evaporated off to form a dry material. The dry material may be calcined at a temperature of 200° C. to 400° C., or preferably at 350° C. for at least 2 h, at least 4 h, or preferably at least 5 h under atmospheric conditions. The resulting TiO₂ photocatalyst has a total electroconductive material content of about 1 wt. % to about 5 wt. % or about 2 wt. % to about 4 wt %.

### B. Water-Splitting System

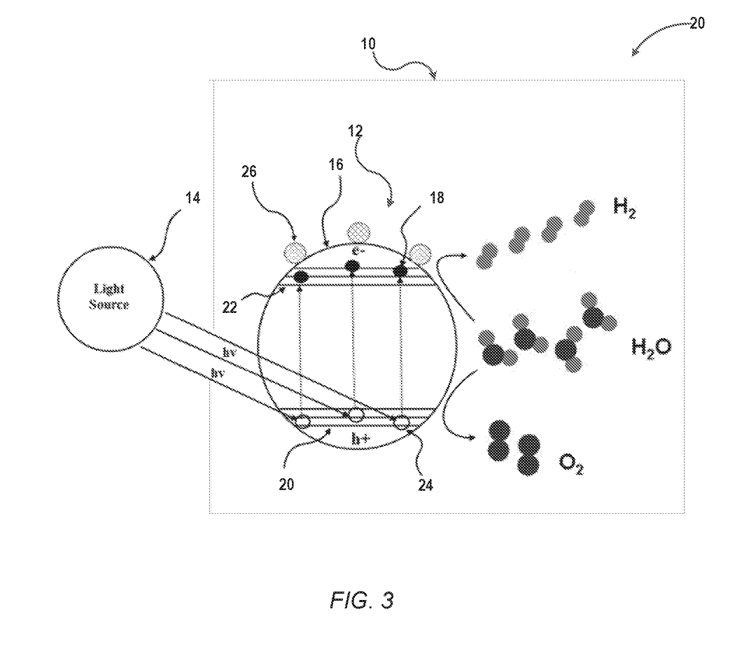

FIG. 3 is a schematic of an embodiment of water-splitting system 20. Water-splitting system 20 includes container 10, photocatalyst 12, and light source 14. Container 10 can be translucent or even opaque such as those that can magnify light (e.g., opaque container having a pinhole(s)). Photocatalyst 12 includes mixed phase titanium dioxide nanoparticles (shown as single nanoparticle 16) having a ratio of anatase phase to rutile phase of at least 1.5:1, and electroconductive material. Light source 14 is sunlight, a UV lamp, or an Infrared (IR) lamp. An example of a UV light is a 100 Watt ultraviolet lamp with a flux of about 2 mW/cm² at a distance of 10 cm. The UV lamp can be used with a 360 nm and above filter. Such UV lamps are commercial available from, for example, Sylvania. Photocatalyst 12 can be used to split water to produce H₂ and O₂. Light source 14 contacts photocatalyst 12, thereby exciting electrons 18 from their valence band 20 to their conductive band 22, thereby leaving corresponding holes 24. Excited electrons 18 are used to reduce hydrogen ions to form hydrogen gas, and holes 24 are used to oxidize oxygen ions to oxygen gas. The hydrogen gas and the oxygen gas can then be collected and used in down-stream processes. Due to electroconductive material 26 deposited on the surface of mixed phase titanium dioxide particles 16, excited electrons 18 are more likely to be used to split water before recombining with holes 24 than would otherwise be the case. While electrically conductive material 26 is shown deposited on the outside surface of titanium dioxide particle 16, some of the electrically conductive material may reside in the pore structure of the titanium dioxide particles. Notably, system 20 does not require the use of an external bias or voltage source. Further, the efficiency of system 20 allows for one to avoid or use minimal amounts of a sacrificial agent.

In addition to being capable of catalyzing water splitting without an external bias or voltage, the photocatalysts of the present invention may be included in an anode of an electrochemical cell capable of forming oxygen and hydrogen by electrolysis of water. In a non-limiting example, light energy may be provided to a photocell and from the light energy a voltage between the anode and the cathode is produced and water molecules are split to form hydrogen and oxygen. The method can be practiced such that the hydrogen production rate from water can be modified as desired by subjecting the system to various amounts of light or light flux.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### Photocatalyst Preparation

Synthesis of mixed phase TiO₂ nanoparticle samples A-E. Single phase titanium dioxide anatase nanopowder was commercially purchased (Sigma Aldrich®). The nanopowder had a surface area of about 55 m²/g_{catalyst} and a particle size of about 20 nm. The nanopowder was annealed isochronally for 1 hour at different temperatures in the range of 700° C. to 800° C. to obtain mixed phase TiO₂ nanoparticle samples A-E. The temperatures and amounts of rutile phase in the samples are listed in Table 1. Table 1 also lists the surface area and particle size of the anatase phase and the rutile phase in the samples. The amount of rutile phase was determined using XRD as described above. The particle size was determined using the Scherrer equation based on the main diffraction line.

Synthesis of mixed phase TiO₂ microparticle comparison samples F-L. Single phase titanium dioxide anatase micropowder was commercially purchased (Fisher Scientific). The micropowder had a surface area of about 10 m²/g_{catalyst} and a particle size of about 100 nm. The micropowder was annealed isothermally at 1000° C. from 1 to 10 hours to obtain mixed phase TiO₂ microparticle samples F-L. The temperature and amounts of rutile phase in the samples is listed in Table 1. Table 1 also lists the surface area and the rutile phase in microparticle samples F-L. The amount of rutile phase was determined using XRD as described above.

Deposition of Pt on mixed phase TiO₂ materials. The mixed phase TiO₂ nanoparticles and mixed phase TiO₂ microparticles were impregnated with platinum. The platinum precursor solution was prepared by dissolving a calculated amount of platinum chloride (PtCl₂) in 1 normal hydrogen chloride. The calculated amount of precursor solution was then contacted with each of samples A-L. The impregnated mixtures were subjected to stirring and were left at 70-80° C. overnight. The resulting slurries were then dried at 100° C. for 24 hours, followed by calcination at 350° C. for 5 hours in air. The resulting nanoparticle photocatalysts (photocatalysts A-E) and microparticle comparison photocatalysts (photocatalysts F-L) had an elemental platinum content of 1 wt. % based on the total weight of the catalyst.

TABLE 1

| | Tem- | | | | |
|---|---|---|---|---|---|
| | perature | | BET | d (anatase) | d (rutile) |
| Sample | (° C.) | % Rutile | (m2/g) | nm | nm |
| TiO₂ Anatase | — | 0 | 55 | 22 | 0 |
| (nanoparticles) | | | | | |
| A | 720 | 3 | 30 | 32 | 8 |
| B | 740 | 10 | 20 | 38 | 38 |
| C | 760 | 29 | 15 | 40 | 76 |
| D | 780 | 37 | 13.5 | 45 | 87 |
| E | 800 | 56 | 11 | 48 | 97 |
| TiO₂ Anatase | | | | | |
| Microparticles | | | | | |
| F | 1000 | 0 | 10 | not | 0 |
| | | | | determined | |
| G | 1000 | 0.5 | 9.8 | 93 | — |
| H | 1000 | 1.2 | 5.4 | 97 | 108 |
| I | 1000 | 7.6 | 5.2 | 103 | 114 |
| J | 1000 | 25 | 6 | 95 | 101 |
| K | 1000 | 68 | 4.5 | 100 | 118 |
| L | 1000 | 78 | 4.5 | 110 | 122 |

Characterization of Photocatalysts: Characterization of the produced photocatalysts was performed with BET surface areas determination, X-Ray diffraction, X-ray photoelectron spectroscopy, Raman spectroscopy, and transmission electron microscopy.

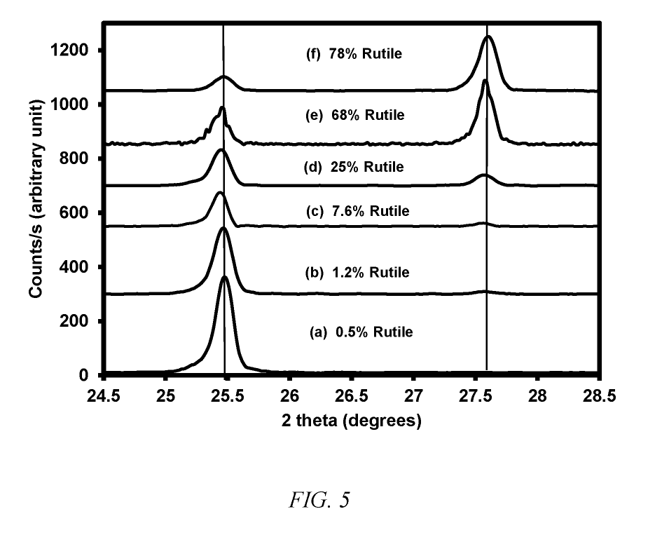

X-Ray Diffraction (XRD): Powder XRD patterns of samples A-L were recorded on a Philips X′pert-MPD X-ray powder diffractometer. A 2 θ interval between 10 and 90 θ was used with a step size of 0.10 θ and a step time of 0.5 seconds. The X-ray was a Ni-filtered Cu Kα radiation source (K═=1.5418 Å), operated at 45 mA and 40 KV. The percentages of rutile were calculated using Equation (1) above and listed in Table 1. The anatase to rutile ratio was calculated by taking the intensity of anatase phase (101) peak at 2 θ=25.30° and rutile phase (110) peak at 2 θ=27.40°. Peak positions of anatase (101) and rutile (110) for nanoparticles A-E were shifted with increasing annealing temperature. Peak shifts of 0.3 degrees were observed in 2 θ values of anatase (101) and rutile (110) from 720° C. to 780° C. A reduction in lattice constants “a” (0.047 Å) and “c” (0.13.1 Å) was observed with an increase in annealing temperature from 720° C. to 780° C. (crystallite size of 45 nm). Peak positions of anatase (101) and rutile (110) for microparticles F-L were in agreement with reported values except for samples I and L, which had a shift in the peaks at lower 2 θ angles. FIG. 4 is a graphical depiction of photocatalysts A-E of the transformation of the anatase phase to the rutile phase when an anatase nanoparticle powder is heated between 720° C. and 780° C. for one hour. In FIG. 4, the anatase phase (101) peak is at 2 theta=25.5 degree and the rutile phase (110) peak is at 2 theta=27.7 degrees. Data (a) represents heating single phase TiO2 anatase at 720° C. for one hour. Data (b) represents heating the single phase TiO₂ anatase at 740° C. Data (c) represents heating the single phase TiO₂ anatase at 760° C. Data (d) represents heating the single phase TiO₂ anatase at 780° C. Data (e) represents heating the single phase TiO₂ anatase at 80° C. FIG. 5 are XRD spectra of microparticle comparison photocatalysts F-L. The metals are not seen by XRD due to their concentrations being too weak to detect.

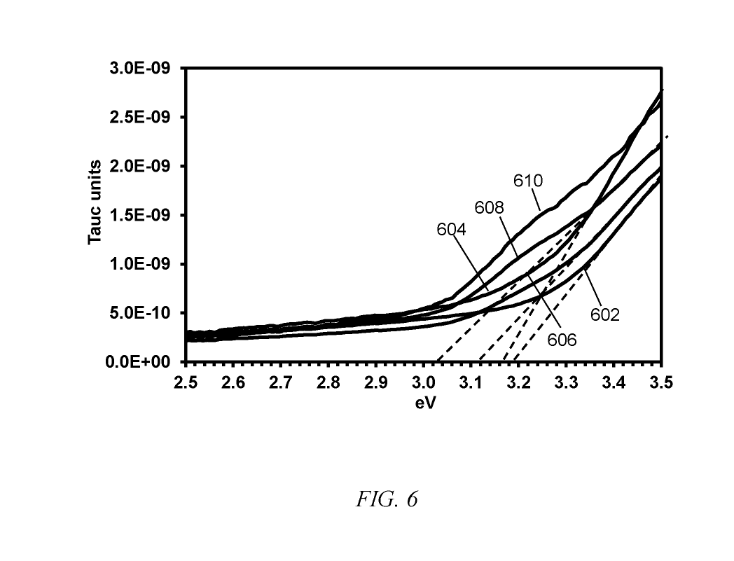

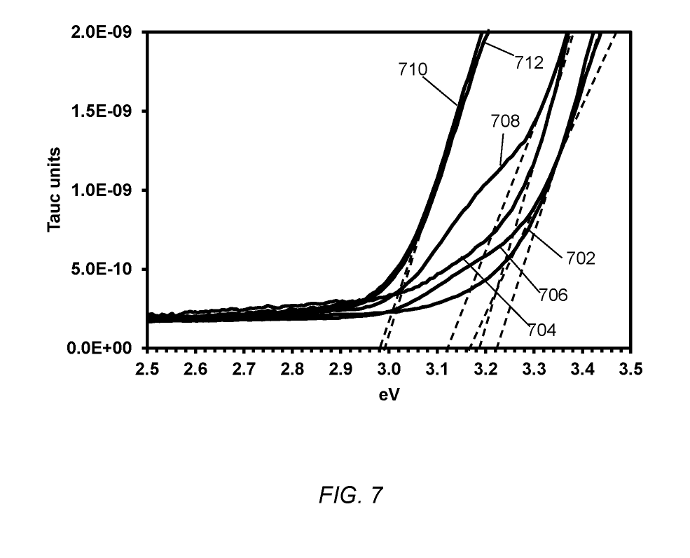

UV Absorption: UV-Vis absorbance spectra of the powdered catalysts were collected over the wavelength range of 250-900 nm on a Thermo Fisher Scientific UV-Vis spectrophotometer equipped with praying mantis diffuse reflectance. Samples were grounded using mortar and pestle before being introduced into the praying mantis chamber using a sample cup. Reflectance (% R) of the samples was measured. A 100 Watt ultraviolet lamp (H-144GC-100, Sylvania par 38) was used as a UV source with a flux of up to 3 mW/cm², depending on the distance from the source, with the cut off filter (360 nm and above). The Kubelka-Munk function, F(R)=(1−R)²/(2R), was used to calculate the optical absorbance from the reflectance (R) of the samples compared to the standard. Band gap was estimated from the Tauc plot of the quantity (F(R) E)^{1/2} against the radiation energy. FIG. 6 depicts UV-Vis spectra of absorbance in Tauc units versus electron volts (eV) of 1 wt. % Pt/TiO₂ nanoparticle photocatalysts A-E with different percentages of rutile. Data line 602 is 0% rutile, data line 604 is 3% rutile, data line 606 is 10% rutile, data line 608 is 29% rutile, and data line 610 is 37% rutile. The dotted lines are the slope of each of the respective lines. FIG. 7 depicts a UV-Vis spectrum of absorbance in Tauc units versus electron volts (eV) of 1 wt. % Pt/TiO₂ microparticle comparison photocatalysts F-L with different percentages of rutile. The rise above 3.0 eV is due to the absorption of TiO₂. Data line 702 is 0.5% rutile, data line 704 is 1.2% rutile, data line 706 is 7.6% rutile, data line 708 is 25% rutile, data line 710 is 68% rutile, and data line 712 is 78% rutile. As shown in FIG. 6, the pure anatase has a band gap of 3.2 eV and with the increase in rutile content the band gap decreases up to 3.0 eV with the maximum rutile content of 37%. As shown in FIG. 7, the decrease in band gap up to 3.0 eV for the microparticle photocatalyst was observed with an increase in rutile content, however, the rutile content was 78%.

Based on the observed band gap data, one would expect that the comparison photocatalysts containing mixed phase TiO₂ microparticles having up to 78% rutile and the photocatalyst of the invention having mixed phase TiO₂ nanoparticles having up to 38% rutile would have similar hydrogen production rates in a water-splitting process.

X-Ray Photoelectron Spectroscopy (XPS): XPS was conducted using a Thermo scientific ESCALB 250 Xi. The base pressure of the chamber ranged from 10-10 to 10-11 mbar. Charge neutralization was used for all samples. Spectra were calibrated with respect to C1s at 285.0 eV, Pt4f, O1s, Ti2p, C1s, and valence band energy regions were scanned for all materials. Typical acquisition conditions were as follows: pass energy=30 e V and scan rate=0.1 e V per 200 ms. Argon ion bombardment was performed with an EX06 ion gun at 1 kV beam energy and 10 rnA emission current; sample current was typically 0.9-1.0 nA. Self-supported oxide disks of approximately 0.5 cm diameter were loaded into the chamber for analysis.

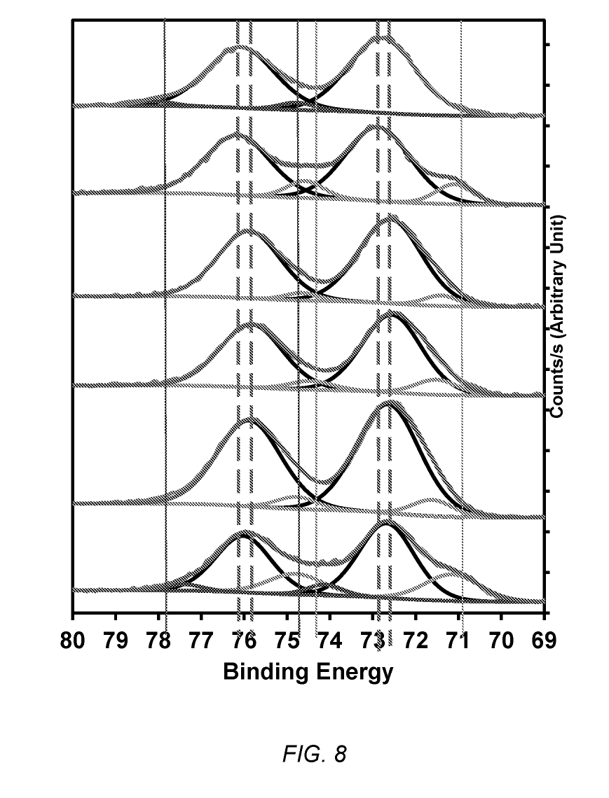

FIG. 8 are XPS spectra of the Pt4f of 1 wt. % Pt/TiO₂ microparticle photocatalysts F-L. The chemical compositions of Pt on the surface, the ratios of Pt4f/Ti2p and O1s/Ti2p were calculated using the corrected area under the XPS curves of Pt4f_{7/2} and Pt4f_{5/2} and are listed in Table 2. Platinum was mostly present in the oxidized form in all samples (Pt²⁺). The peaks at 72.6-72.8 eV were assigned to Pt4f_{7/2} of Pt²⁺ while the peaks at 75.9- 76.1 eV were assigned to Pt4f_{5/2} of Pt²⁺. The peak positions at 71.5 eV were related to Pt4f_{7/2} of metallic Pt peak, while peaks at 74.8 eV were attributed to Pt4f_{5/2} of Pt⁰. The metallic percentage of Pt was more pronounced in the sample containing 100% anatase.

TABLE 2

| % Rutile | | Atomic % | Pt4f/Ti2P | O1s/Ti2P |
|---|---|---|---|---|
| 0.5 | Pt4f | 1.1 | 0.05 | |
| | Ti2P | 24.2 | | |
| | O1s | 53.3 | | |
| | C1s | 21.3 | | |
| 1.2 | Pt4f | 1.6 | 0.07 | |
| | Ti2P | 23.5 | | |
| | O1s | 52.4 | | |
| | C1s | 22.3 | | |
| 7.6 | Pt4f | 1.1 | 0.05 | |
| | Ti2P | 23.4 | | |
| | O1s | 52.8 | | |
| | C1s | 22.5 | | |
| 25 | Pt4f | 1.2 | 0.05 | |
| | Ti2P | 22.5 | | |
| | O1s | 52.4 | | |
| | C1s | 23.5 | | |
| 68 | Pt4f | 0.9 | 0.04 | |
| | Ti2P | 24.1 | | |
| | O1s | 56.1 | | |
| | C1s | 18.9 | | |
| 78 | Pt4f | 1.9 | 0.04 | 2.3 |
| | Ti2P | 23.7 | | |
| | O1s | 55.1 | | |
| | C1s | 20.2 | | |

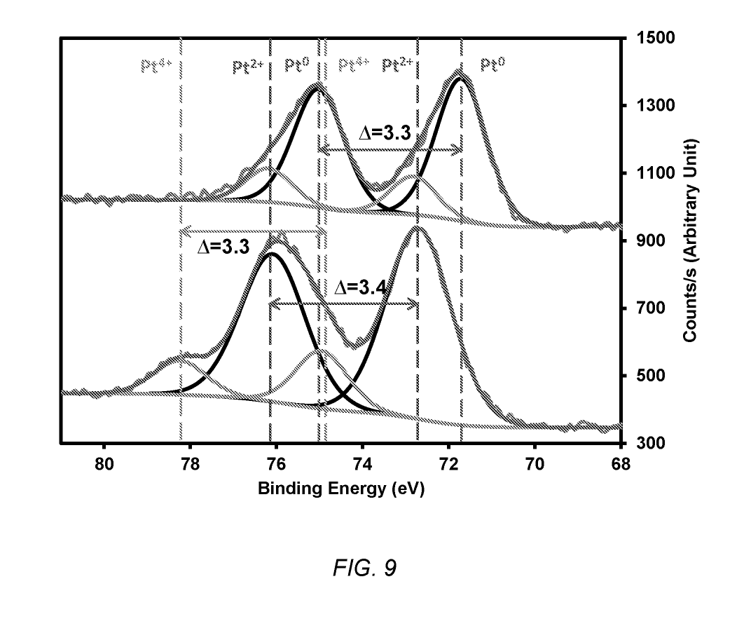

FIG. 9 are XPS spectra of the Pt4f of photocatalyst B having 1 wt. % Pt/TiO₂ nanoparticles having 10% rutile and comparison photocatalyst having 1 wt. % Pt/TiO₂ anatase (100%). XPS analysis was carried out for these samples before and after Ar ion sputtering. The oxidation states of Pt in the non-Ar sputtered samples are attributed to Pt²⁺ and Pt⁴⁺. The peaks at 72.7 and 76.0 eV are attributed to Pt4f_{7/2} and Pt4f_{5/2} of Pt²⁺ while peaks at 75.0 and 78.2 eV corresponded to Pt4f_{7/2} and Pt4f_{5/2} of Pt²⁺. After Ar ion sputtering for 5 minutes, the nanoparticle sample was reduced and the oxidation states of Pt changed to metallic platinum; peaks positions shifted to the lower binding energy at 71.7 and 75.0 for Pt4f_{7/2} and Pt4f_{5/2} of Pt⁰ with the difference in the splitting binding energies of 3.3 eV.

Based on the data obtained from XPS, the photocatalysts of the invention have a band gap between about 3.0 eV and 3.2 eV.

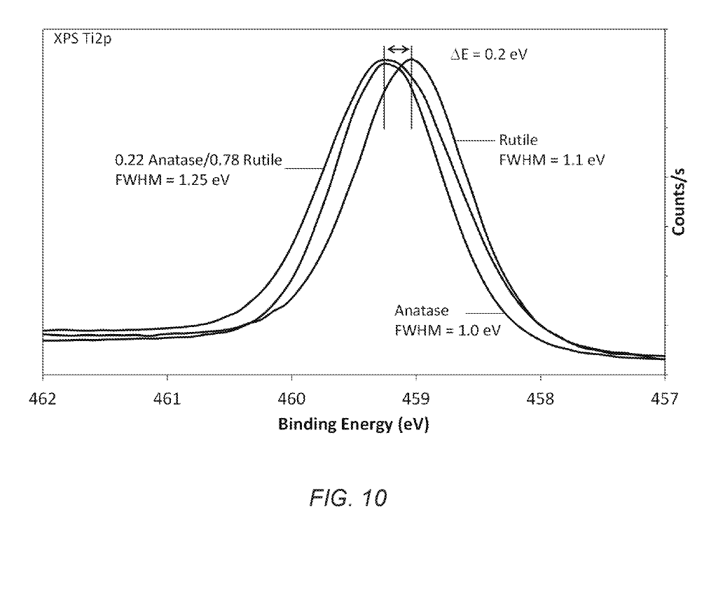

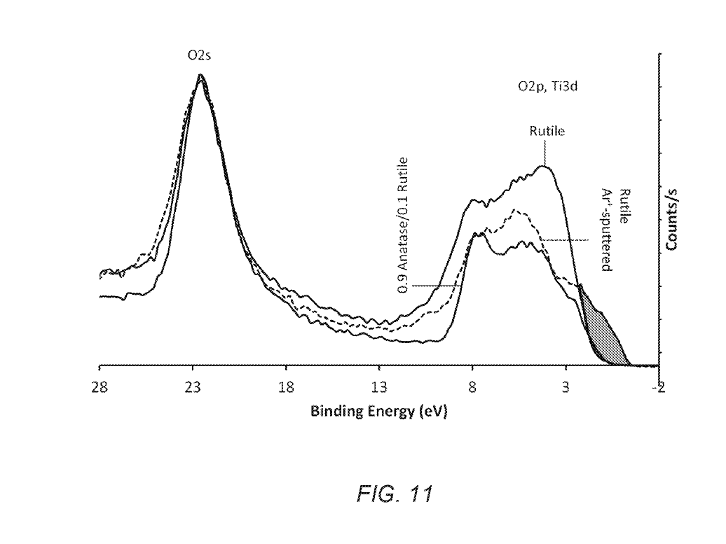

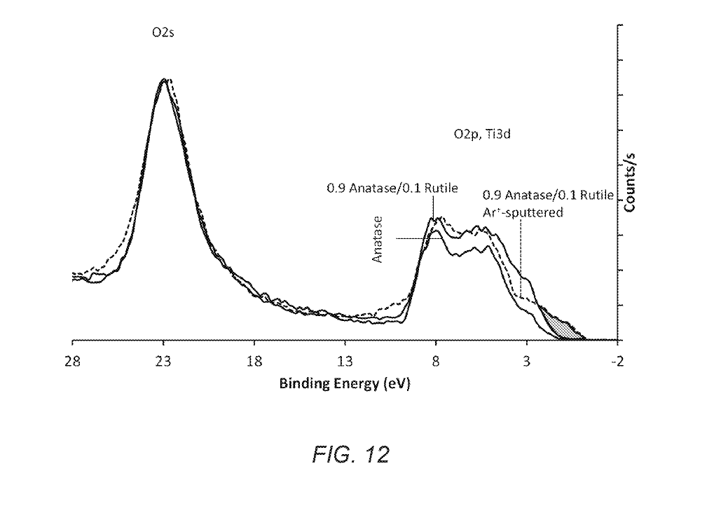

FIG. 10 are XPS spectra of the Ti2p of pure rutile, pure anatase, and the mixed phase microparticles (78% rutile, comparison sample L). The spectra were aligned to the C1s at 285.0 eV. The Ti2p of rutile is found to be about 0.2 eV lower in binding energy compared to that of anatase. The narrow full width half maximum (FWHM) of all the samples indicated that no contribution of reduced states was present. It should be noted that the FWHM of the Ti2p_{3/2} of the mixed phase sample is larger than that of FWHM of the Ti2p_{3/2} the samples containing rutile alone or anatase alone. FIGS. 11 and 12 depict the XPS of the Valence Band region of pure 1 wt. % Pt/TiO₂ rutile, 1 wt. % Pt/TiO₂ anatase, and 1 wt. % Pt/TiO₂ mixed phase after AR ions sputtering. The spectra are aligned to the O2s binding energy and the base line is shifted so all spectra have the same initial offset for better comparison. The alignment to the O2s prevented the effect of any possible nonlinearity in the spectrometer because the C1s region is relatively far (260 eV above the O2p region). Non-Ar sputtered material was compared to that of the sputtered material to see into any effect due to the presence of Ti3d states associated with oxygen defects. In FIG. 11, the rutile VB with its finger print of the O2p shape was evident. Ar ion sputtering resulted in the appearance of lines extending from about 1 eV below the Fermi level (shaded area). As shown in FIG. 11, the mixed phase TiO₂ has the O2p shape dominated by that of anatase. FIG. 12 depicts similar spectra as FIG. 11, but starting from pure anatase. Inspection of both figures indicate that the VBM of anatase is at a lower energy than that of rutile and that the mixed phase materials is somewhere in between. Based on FIGS. 11 and 12, the VBM of the mixed phase material falls in between that of anatase and that of rutile.

### Example 2

### Use of Photocatalysts in Water-Splitting Reactions

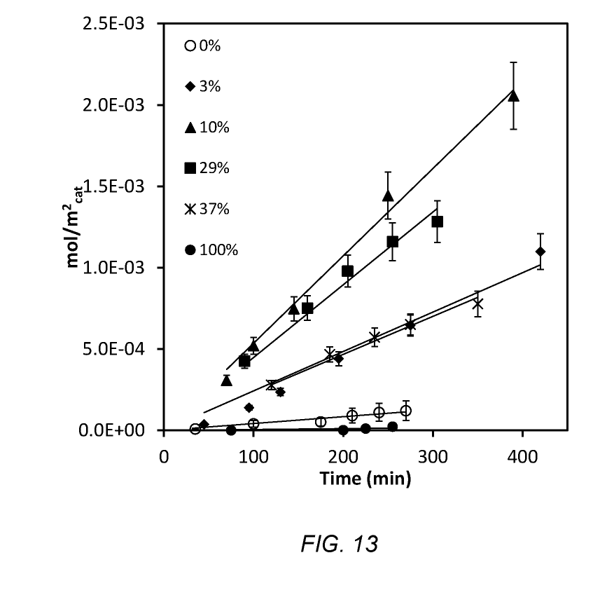

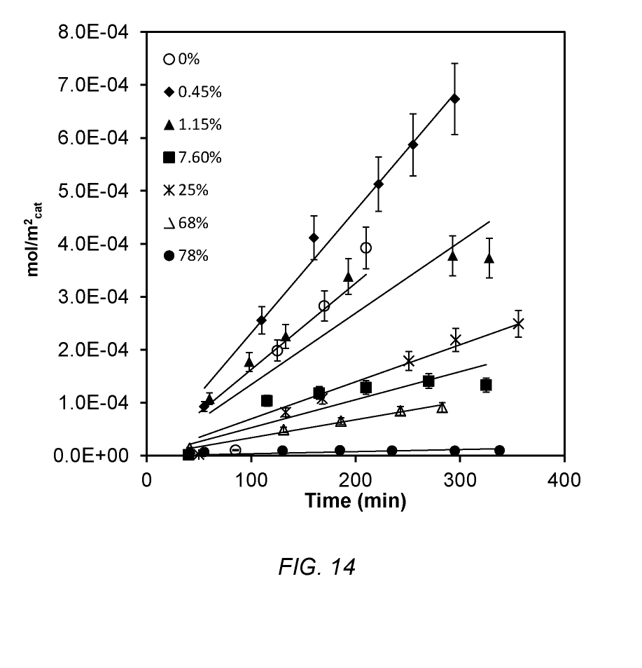

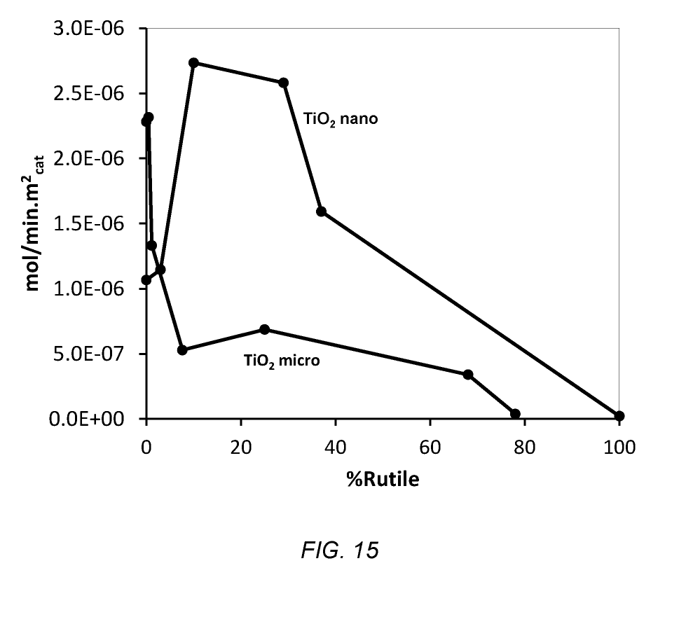

Experimental Set-Up: Catalytic reactions were conducted in a borosilicate (Pyrex®, Corning) glass reactor having a capacity of 100 mL. For each experiment, a photocatalyst was added to the glass reactor in a concentration of 0.1 g/L (25 mg in 21 mL total volume). The photocatalyst was reduced under hydrogen flow at 350° C. for 1 h followed by purging with nitrogen gas for 30 minutes. Deionized water (20 mL) and sacrificial agent (ethanol, 5 v/v % based on total water, 1 mL) were added to the reactor. The reaction mixture was irradiated with sunlight, with a light flux at the front side of the reactor of between 0.3 and 1 mW/cm². The mixture containing photocatalyst, water and sacrificial agent was stirred constantly under dark conditions to disperse the catalyst and sacrificial agent in the water. The reactor was then exposed to a UV light source (100 Watt UV lamp (H-144GC-100, Sylvania par 38) with a flux of about 2 mW/cm² at a distance of 10 cm with the cut off filter (360 nm and above). Product analysis of the produced gas was done using a gas chromatography (Porapak™ Q (Sigma Aldrich) packed column 2 m, 45° C. (isothermal), with nitrogen as a carrier gas) with a thermal conductivity detector. Hydrogen production rates for reactions run with photocatalysts A-L were normalized with respect to BET surface area of each catalyst. FIGS. 13, 14, and 15 are graphical depictions of hydrogen production in mol/m²_{cat} versus time in minutes for nanoparticles and microparticles of 1 wt. % Pt/TiO₂. FIG. 13 is a graphical depiction of hydrogen production versus time for 1 wt. % Pt/TiO₂ nanoparticles with increasing rutile content. FIG. 14 is a graphical depiction of hydrogen production versus time for 1 wt. % Pt/TiO₂ microparticles with increasing rutile content. FIG. 15 is a graphical depiction of hydrogen production from 1 wt. % Pt/TiO₂ nanoparticles and 1 wt. % Pt/TiO₂ microparticles versus rutile content.

As shown in FIGS. 13-15, 1 wt. % Pt/TiO₂ 100% rutile (pure rutile) produced the least amount of hydrogen, namely 2.6×10⁻⁸ mol/m² per min for the nanoparticles and 5.3×10⁻⁸ mol/m² per min for the microparticles. The rate of hydrogen production using 1 wt. % Pt/TiO₂ 100% anatase was 1×10⁻⁶ mol/m² per min for nanoparticles and about 2.4×10⁻⁶ mol/m² per min for microparticles, which is about 2 orders of magnitude higher than 1 wt. % Pt/TiO₂ 100% rutile. The rate of hydrogen product for the mixed phase photocatalyst containing 1 wt. % Pt/TiO₂ microparticles decreased as the increase in the amount of rutile in the titanium dioxide increased. Thus, one would predict that hydrogen production from a mixed phase photocatalyst containing 1 wt. % Pt/TiO₂ nanoparticles would decrease over time with increasing amounts of rutile phase in the titanium dioxide and be less than the amount of hydrogen produced using the mixed phase titanium dioxide nanoparticles. It was found, however, that when the photocatalysts containing mixed phase titanium dioxide nanoparticles having a ratio of anatase to rutile of at least 1.5 were used, the production of hydrogen was greater than (See, for example, FIG. 15) that of the comparison photocatalyst containing mixed phase titanium dioxide microparticles having a substantially same amount of anatase and rutile phases as the titanium dioxide nanoparticles under the same conditions.

1. A photocatalyst comprising:
(a) mixed phase titanium dioxide nanoparticles having:
a mean particle size of 95 nanometers (nm) or less, and having
a ratio of anatase to rutile of at least 1.5:1 to 10:1, and
a surface area of 15 m²/g to 30 m²/g; and
(b) an electrically conductive material deposited on the surface of the titanium dioxide nanoparticles,
wherein the electrically conductive material comprises a metal or a metal compound thereof,
wherein the mixed phase titanium dioxide nanoparticles are the reaction product of single phase titanium dioxide anatase nanoparticles having a mean particle size of 95 nm or less and heat, and
wherein particle size is determined by X-ray Diffraction and surface area is determined using BET analysis.

2. (canceled)

3. The photocatalyst of claim 1, wherein the anatase phase to rutile phase ratio ranges from 1.5:1 to 5:1.

4. The photocatalyst of claim 1, wherein the mean particle size ranges from 10 nm to 80 nm.

5. The photocatalyst of claim 1, wherein the Ti2p_{3/2} binding energy as determined by X-Ray PhotoElectron Spectroscopy (XPS) falls in between that of single phase TiO₂ anatase particle and a single phase TiO₂ rutile particle.

6. The photocatalyst of claim 1, wherein the electrically conductive material comprises a metal or a metal compound thereof.

7. The photocatalyst of claim 6, wherein the electrically conductive material comprises silver (Ag), rhodium (Rh), gold (Au), platinum (Pt), palladium (Pd) or any combination thereof.

8. (canceled)

9. The photocatalyst of claim 8, wherein the photocatalyst is Pt.

10. (canceled)

11. The photocatalyst of claim 1, wherein the single phase TiO₂ anatase particles have been heated at a reaction temperature of 740° C. for one hour.

12. The photocatalyst of claim 1, wherein the photocatalyst has photocatalytic activity.

13. The photocatalyst of claim 1, wherein the photocatalyst is capable of catalyzing the production of H₂ from water at an increased rate as compared to production of H₂ from water under the same conditions and using a mixed phase titanium dioxide photocatalyst having a substantially same amount of anatase and rutile phases and a particle size of greater than 100 nm.

14. The photocatalyst of claim 13, wherein the photocatalyst is comprised in a composition that includes the water.

15. The photocatalyst of claim 14, wherein the composition further comprises a sacrificial agent.

16. The photocatalyst of claim 15, wherein the sacrificial agent comprises one or more alcohols, diols, polyols, dioic acids, and any combination thereof.

17. The photocatalyst of claim 15, wherein the sacrificial agent comprises methanol, ethanol, propanol, iso-propanol, n-butanol, iso-butanol, ethylene glycol, propylene glycol, glycerol, or oxalic acid, or any combination thereof.

18. (canceled)

19. (canceled)

20. A method of producing a photocatalyst as in claim 1, comprising:
(a) heating single phase titanium dioxide anatase nanoparticles having a mean particle size of 95 nanometers (nm) or less isochronally at a temperature ranging from 700° C. to 800° C. for a desired period of time to produce mixed phase titanium dioxide nanoparticles having a mean particle size of 95 nm or less and a surface area of the mixed phases titanium dioxide nanoparticles ranges from 15 m²/g to 30 m²/g, wherein the mixed phase titanium dioxide nanoparticles comprise anatase and rutile phases at a ratio of at least 1.5:1 to 10:1;
(b) depositing an electrically conductive material on the surface of the mixed phase titanium dioxide nanoparticles, wherein the electrically conductive material comprises a metal or a metal compound thereof.

21. (canceled)

22. The method of claim 20, wherein the electroconductive material comprises silver (Ag), rhodium (Rh), gold (Au), platinum (Pt), palladium (Pd) or mixtures thereof.

23. The method of claim 20, wherein depositing the electroconductive material comprises contacting the mixed phase TiO₂ nanoparticles with an acidic aqueous solution comprising a salt of the electroconductive material.

24. (canceled)

25. The method of claim 20, further comprising calcining the electroconductive material/mixed phase titanium dioxide anatase nanoparticles after step (b).

26. A system for producing H₂ from H₂O, comprising:
(a) a container comprising a mixture of photocatalyst of claim 1, water and a sacrificial agent; and
(b) a light source configured to provide light to the mixture.

27. (canceled)

28. A method for producing H₂ from water, comprising:
(a) obtaining a system of claim 26; and
(b) subjecting the mixture to the light source for a sufficient period of time to produce the H₂ from the water.

29. (canceled)

30. (canceled)
